(19) United States
(12) Patent Application Publication
(10) Pub. No.: US 2003/0213703 A1
(43) Pub. Date: Nov. 20, 2003

(54) Method and apparatus for substrate polishing

(75) Inventors: Yan Wang, Sunnyvale, CA (US); Feng Q. Liu, Cupertino, CA (US); Yongqi Hu, Campbell, CA (US); Alain Duboust, Sunnyvale, CA (US); Liang-Yuh Chen, Foster City, CA (US); Paul D. Butterfield, San Jose, CA (US); Ralph M. Wadensweiler, Sunnyvale, CA (US)

Correspondence Address: APPLIED MATERIALS, INC., 2881 SCOTT BLVD. M/S 2061, SANTA CLARA, CA, 95050, US

(73) Assignee: Applied Materials, Inc.

(21) Appl. No.: 10/151,538

(22) Filed: May 16, 2002

(51) Int. Cl. B23H 3/00

(52) U.S. Cl. 205/662

(57) ABSTRACT

A method and apparatus are provided for polishing a substrate surface. In one aspect, an apparatus for polishing a substrate includes a pad assembly having a conductive pad, a backing and a conductive layer adapted to be biased by a power source. In another embodiment, an apparatus for polishing a substrate includes a pad assembly disposed in a basin. The basin has two electrodes coupled to opposite poles of a power source. Each electrode extends partially through a respective aperture formed in the pad assembly. The apparatus may be part of an electro-chemical polishing station that may optionally be part of a system that includes chemical mechanical polishing stations.

### BACKGROUND OF THE INVENTION

1. Field of the Invention

Embodiments of the present invention relate to a method and apparatus for planarizing a substrate surface.

2. Background of the Related Art

In the fabrication of integrated circuits and other electronic devices, multiple layers of conducting, semiconducting, and dielectric materials are deposited on or removed from a surface of a substrate. Thin layers of conducting, semiconducting, and dielectric materials may be deposited by a number of deposition techniques. Common deposition techniques in modern processing include physical vapor deposition (PVD), chemical vapor deposition (CVD) and electro-chemical plating (ECP).

As layers of materials are sequentially deposited and removed, the uppermost surface of the substrate may become non-planar across its surface and require planarization. Planarizing a surface, or “polishing” a surface, is a process where material is removed from the surface of the substrate to form a generally even, planar surface. Planarization is useful in removing undesired surface topography and surface defects, such as agglomerated materials, crystal lattice damage, scratches, and contaminated layers or materials. Planarization is also useful in forming features on a substrate by removing excess deposited material used to fill the features and to provide an even surface for subsequent levels of metallization and processing.

Chemical mechanical planarization, or chemical mechanical polishing (CMP), is a common technique used to planarize substrates. CMP utilizes a chemical composition, typically a slurry or other fluid medium, for selective removal of material from substrates. In conventional CMP techniques, a substrate carrier or polishing head is mounted on a carrier assembly and positioned in contact with a polishing pad in a CMP apparatus. The carrier assembly provides a controllable pressure to the substrate urging the substrate against the polishing pad. The pad is moved relative to the substrate by an external driving force. The CMP apparatus effects polishing or rubbing movement between the surface of the substrate and the polishing pad while dispersing a polishing composition to effect chemical activity and/or mechanical activity and consequential removal of material from the surface of the substrate.

One material increasingly utilized in integrated circuit fabrication is copper due to its desirable electrical properties. However, copper has its own special fabrication problems. For example, copper is difficult to pattern and etch, and new processes and techniques, such as damascene or dual damascene processes, are being used to form copper substrate features. In damascene processes, a feature is defined in a dielectric material and subsequently filled with copper. Dielectric materials with low dielectric constants, i.e., less than about 3, are being used in the manufacture of copper damascenes. Barrier layer materials are deposited conformally on the surfaces of the features formed in the dielectric layer prior to deposition of copper material. Copper material is then deposited over the barrier layer and the surrounding field. However, copper fill of the features usually results in excess copper material, or overburden, on the substrate surface that must be removed to form a copper filled feature in the dielectric material and prepare the substrate surface for subsequent processing.

One challenge that is presented in polishing copper materials is that the conductive material and the barrier materials are often removed from the substrate surface at different rates, both of which can result in excess conductive material being retained as residues on the substrate surface. Additionally, the substrate surface may have different surface topography, depending on the density or size of features formed therein. Copper material is removed at different removal rates along the different surface topography of the substrate surface, which makes effective removal of copper material from the substrate surface and final planarity of the substrate surface difficult to achieve.

One solution for polishing copper in low dielectric materials with reduced or minimal defects formed thereon is by polishing copper by electrochemical mechanical polishing (ECMP) techniques. ECMP techniques remove conductive material from a substrate surface by electrochemical dissolution while concurrently polishing the substrate with reduced mechanical abrasion compared to conventional CMP processes. The electrochemical dissolution is typically performed by applying an electrical bias between a cathode and substrate surface to remove conductive materials from a substrate surface into a surrounding electrolyte. During electrochemical dissolution, the substrate typically is placed in motion relative to a polishing pad to enhance the removal of material from the surface of the substrate. In one embodiment of an ECMP system, the electrical bias is applied by conductive contacts projecting from a polishing pad. The conductive contacts contact the substrate surface during polishing to electrically bias the substrate.

Some ECMP systems employ a conductive ring to bias the substrate during processing. However, the conductive ring may not continuously and/or evenly contact the substrate around the circumference of the ring, resulting in non-uniform electric fields across the substrate's diameter that resulting in poor process uniformity. Moreover, the electric field strength is typically stronger close to the conductive ring, disadvantageously resulting in faster processing near the substrate's edge.

One ECMP system that substantially reduces non-uniformities associated with conductive contact ring used in ECMP processing uses a polishing pad having conductive elements embedded therein. The conductive elements, for example, a plurality of brushes, project from the polishing pad to contact a substrate being processed on the polishing pad.

After a number of polishing cycles, the electrical elements require replacement in order to ensure good polishing performance. Additionally, it is difficult to condition the polishing pad without damaging the electrical elements. Thus, the full life of the polishing pad is often not realized. Accordingly, the necessity to replace the electrical elements and polishing pad adversely impacts the cost of consumables (i.e., components and fluids consumed during processing).

Therefore, there is a need for an improved polishing apparatus.

### SUMMARY OF THE INVENTION

Aspects of the invention generally provide a method and apparatus for polishing a layer on a substrate using electrochemical deposition techniques, electrochemical dissolution techniques, polishing techniques, and/or combinations thereof. In one aspect, an apparatus for polishing a substrate includes a pad assembly having a conductive pad, a backing and a conductive layer adapted to be biased by a power source. The pad assembly is configured as a unitary body to facilitate replacement in an electrochemical processing system.

In another embodiment, an apparatus for polishing a substrate includes a basin having a first electrode and a second electrode coupled to a bottom of the basin. A dielectric pad is disposed in the basin and has a first aperture and second aperture formed therethrough. The first electrode extends partially through the first aperture while the second electrode extends partially through the second aperture.

In another aspect of the invention, a method for electro-chemical processing a substrate is provided. In one embodiment, a method for electro-chemical processing a substrate includes the steps of placing the substrate in contact with a surface of a dielectric pad having a first aperture and a second aperture formed in the surface, moving the substrate and the dielectric pad relative to each other, creating a first conductive path between an anode and the substrate through the first aperture, and creating a second conductive path between a cathode and the substrate through the second aperture.

### BRIEF DESCRIPTION OF THE DRAWINGS

A more particular description of the invention, briefly summarized above, may be had by reference to the embodiments thereof that are illustrated in the appended drawings. It is to be noted, however, that the appended drawings illustrate only typical embodiments of this invention and, therefore, are not to be considered limiting of its scope, for the invention may admit to other equally effective embodiments.

FIG. 1 is a sectional view of one embodiment of a processing cell of the invention;

FIG. 2 is an exploded sectional view of one embodiment of a pad assembly;

FIGS. 3A-B are various embodiments of conductive pads;

FIGS. 4-B are partial sectional views of another embodiment of a processing cell;

FIG. 4C is a top view of one embodiment of a pad assembly shown in the processing cell of FIG. 4A;

FIG. 5 is a sectional view of another embodiment of a processing cell;

FIG. 6 is a plan view of one embodiment of a polishing system; and

FIG. 7 is a sectional view of another embodiment of a processing cell.

To facilitate understanding, identical reference numerals have been used, wherever possible, to designate identical elements that are common to the figures.

### DESCRIPTION OF THE PREFERRED EMBODIMENT

The words and phrases used herein should be given their ordinary and customary meaning in the art by one skilled in the art unless otherwise further defined herein. Chemical-mechanical polishing should be broadly construed and includes, but is not limited to, abrading a substrate surface by chemical activity, mechanical activity, or a combination of both chemical and mechanical activity. Electropolishing should be broadly construed and includes, but is not limited to, planarizing a substrate by the application of electrochemical activity. Electrochemical mechanical polishing (ECMP) should be broadly construed and includes, but is not limited to, planarizing a substrate by the application of electrochemical activity, or a combination of both electrochemical and mechanical activity to remove material from a substrate surface. Electrochemical mechanical plating process (ECMPP) should be broadly construed and includes, but is not limited to, electrochemically depositing material on a substrate and concurrently planarizing the deposited material by the application of electrochemical activity, or a combination of both electrochemical and mechanical activity.

Anodic dissolution should be broadly construed and includes, but is not limited to, the application of an anodic bias to a substrate directly or indirectly which results in the removal of conductive material from a substrate surface and into a surrounding electrolyte solution. Aperture should be broadly construed and includes, but is not limited to, a perforation, hole, opening, groove, channel, or passage formed partially or completely through an object. Additionally, the term substantially as used to modifying the term planar is intended to describe a surface on a macroscopic or global level and not surface roughness.

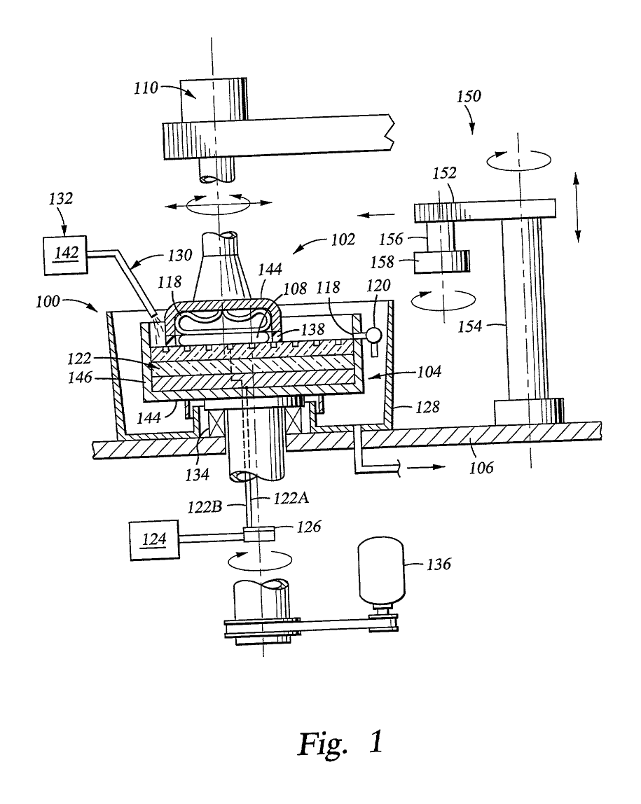

FIG. 1 depicts a sectional view of one embodiment of a process cell 100 in which at least one process comprising anodic dissolution, plating and polishing processes may be practiced. The process cell 100 generally includes a basin 104 and a polishing head 102. A substrate 108 is retained in the polishing head 102 and lowered into the basin 104 during processing in a face-down (e.g., backside up) orientation. An electrolyte is flowed into the basin 104 and in contact with the substrate's surface while the polishing head 102 places the substrate 108 in contact with a pad assembly 122. The substrate 108 and the pad assembly 122 disposed in the basin 104 are moved relative to each other to provide a polishing motion (or motion that enhances plating uniformity). The polishing motion generally comprises at least one motion defined by an orbital, rotary, linear or curvilinear motion, or combinations thereof, among other motions. The polishing motion may be achieved by moving either or both of the polishing heads 102 and the basin 104. The polishing head 102 may be stationary or driven to provide at least a portion of the relative motion between the basin 104 and the substrate 108 held by the polishing head 102. In the embodiment depicted in FIG. 1, the polishing head 102 is coupled to a drive system 110. The drive system 110 moves the polishing head 102 with at least a rotary, orbital, sweep motion or combinations thereof.

The polishing head 102 generally retains the substrate 108 during processing. In one embodiment, the polishing head 102 includes a housing 114 enclosing a bladder 116. The bladder 116 may be deflated when contacting the substrate to create a vacuum therebetween, thus securing the substrate to the polishing head 102. The bladder 116 may additionally be inflated to press the substrate in contact with the pad assembly 122 retained in the basin 104. A retaining ring 138 is coupled to the housing 114 and circumscribes the substrate 108 to prevent the substrate from slipping out from the polishing head 102 while processing. One polishing head that may be adapted to benefit from the invention is a TITAN HEAD™ carrier head available from Applied Materials, Inc., located in Santa Clara, Calif. Another example of a polishing head that may be adapted to benefit from the invention is described in U.S. Pat. No. 6,159,079, issued Dec. 12, 2001, which is hereby incorporated herein by reference in its entirety.

The basin 104 is generally fabricated from a plastic such as fluoropolymers, TEFLON®, PFA, PE, PES, or other materials that are compatible with electroplating and electropolishing chemistries. The basin 104 includes a bottom 144 and sidewalls 146 that define a container that houses the pad assembly 122.

The sidewalls 146 include a port 118 formed there through to allow removal of electrolyte from the basin 104. The port 118 is coupled to a valve 120 to selectively drain or retain the electrolyte in the basin 104.

The basin 104 is rotationally supported above a base 106 by bearings 134. A drive system 136 is coupled to the basin 104 and rotates the basin 104 during processing. A catch basin 128 is disposed on the base 106 and circumscribes the basin 104 to collect processing fluids, such as an electrolyte, that flow out of port 118 disposed through the basin 104 during and/or after processing.

An electrolyte delivery system 132 is generally disposed adjacent the basin 104. The electrolyte delivery system 132 includes a nozzle or outlet 130 coupled to an electrolyte source 142. The outlet 130 flows electrolyte or other processing fluid from the electrolyte source 142 to into the basin 104. During processing, the electrolyte generally provides an electrical path for biasing the substrate 108 and driving an electro-chemical process to remove and/or deposit material on the substrate 108.

One electrolyte that can be used for processing the substrate 108 facilitates electrochemical removal and/or deposition of metals such as copper, aluminum, tungsten, gold, silver or other materials from or onto the substrate 108. Electrolyte solutions may include commercially available electrolytes. For example, in copper containing material removal, the electrolyte may include sulfuric acid based electrolytes or phosphoric acid based electrolytes and potassium phosphate (K₃PO₄), or combinations thereof. The electrolyte may also contain derivatives of sulfuric acid based electrolytes, such as copper sulfate, and derivatives of phosphoric acid based electrolytes, such as copper phosphate. Electrolytes having perchloric acid-acetic acid solutions and derivatives thereof may also be used. Additionally, the invention contemplates using electrolyte compositions conventionally used in electroplating or electropolishing processes, including conventionally used electroplating or electropolishing additives, such as brighteners among others. In one aspect of the electrolyte solution, the electrolyte may be made of components (such as copper sulfate, for instance) having a concentration between about 0.2 and about 1.2 Molar of the solution.

As one example, copper sulfate (CuSO₄) can be used as the electrolyte. One source for electrolyte solutions used for electrochemical processes such as copper plating, copper anodic dissolution, or combinations thereof is Shipley Leonel, a division of Rohm and Haas, headquartered in Philadelphia, Pa., sold under the trade name ULTRAFILL 2000. Another example of an electrolyte is described in U.S. patent application Ser. No. ______ , filed ______ by L. Sun, et al., (Attorney Docket No. 6712) entitled “ELECTROLYTE WITH GOOD PLANARIZATION CAPABILITY, HIGH REMOVAL RATE AND SMOOTH SURFACE FINISH FOR ELECTROCHEMICALLY CONTROLLED COPPER CMP”.

A conditioning device 150 may be provided proximate the basin 104 to periodically condition or regenerate the pad assembly 122. Typically, the conditioning device 150 includes an arm 152 coupled to a stanchion 154 that is adapted to position and sweep a conditioning element 158 across pad assembly 122. The conditioning element 158 is coupled to the arm 152 by a shaft 156 to allow clearance between the arm 152 and sidewalls 146 of the basin 104 while the conditioning element 158 is lowered to contact the pad assembly 122. The conditioning element 158 is typically a diamond or silicon carbide disk, which may be patterned to enhance working the surface of the pad assembly 122 into a predetermined surface condition/state that enhances process uniformity. One conditioning element 158 that may be adapted to benefit from the invention is described in U.S. patent application Ser. No. 09,676,280, filed Sep. 28, 2000 by Li et al., which is hereby incorporated by reference in its entirety.

A power source 124 is coupled to the pad assembly 122 by electrical leads 112 (shown as 112A-B). The power source 124 applies an electrical bias to the pad assembly 122 to drive an electrochemical process as described further below. The leads 112 are routed through a slip ring 126 disposed below the basin 104. The slip ring 126 facilitates continuous electrical connection between the power source 124 and the pad assembly 122 as the basin 104 rotates. The leads 112 typically are wires, tapes or other conductors compatible with process fluids or having a covering or coating that protects the leads 112 from the process fluids. Examples of materials that may be utilized in the leads 112 include insulated copper, graphite, titanium, platinum, gold, and HASTELOY® among other materials. Coatings disposed around the leads 112 may include polymers such as fluorocarbons, PVC, polyamide, and the like.

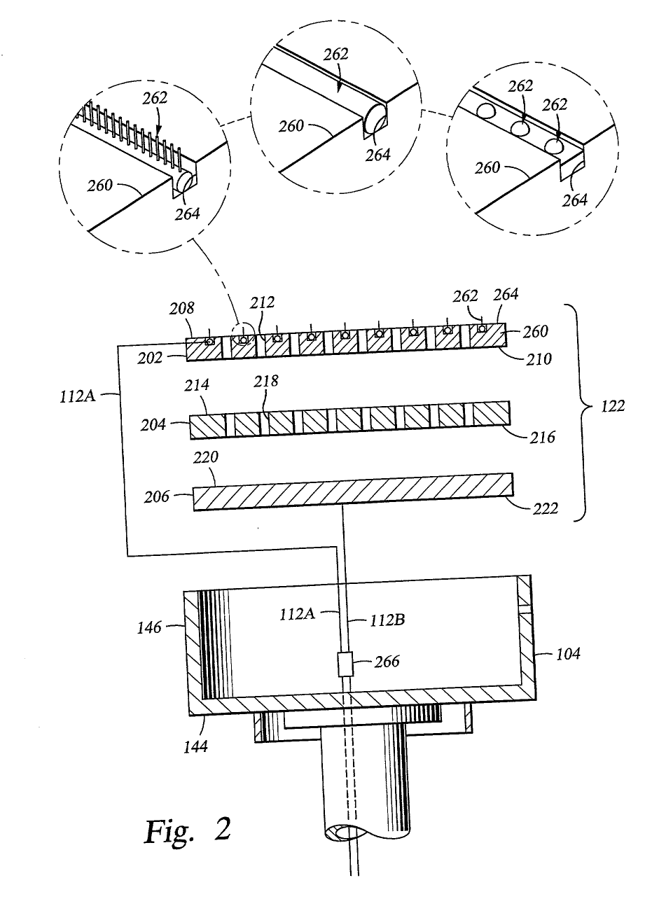

FIG. 2 depicts an exploded sectional view of one embodiment of the pad assembly 122 that is removably disposed in the basin 104. While the exemplary pad assembly 122 is described for an electrochemical-mechanical polishing (ECMP) process, the invention contemplates using the conductive polishing media (pads) in other fabrication processes involving electrochemical activity. Examples of such processes using electrochemical activity include electrochemical deposition, which involves a pad assembly 122 being used to apply a uniform bias to a substrate surface for depositing a conductive material without the use of a conventional bias application apparatus, such as edge contacts, and electrochemical mechanical plating processes (ECMPP) that include a combination of electrochemical deposition and chemical mechanical polishing. As the pad assembly 122 includes elements comprising both an anode and cathode of an electrochemical cell, both the anode and cathode may be replaced simultaneously by simply removing a used pad assembly 122 from the basin 104 and inserting a new pad assembly 122 with fresh electrical components into the basin 104.

The pad assembly 122 depicted in FIG. 2 includes a conductive pad 202 coupled to a backing 204. The backing 204 is coupled to an electrode 206. Typically, the conductive pad 202, the backing 204 and the electrode 206 are secured together forming a unitary body that facilitates removal and replacement of the pad assembly 122 from the basin 104. Typically, the conductive pad 202, the backing 204 and the electrode 206 are adhered or bonded to one another. In the embodiment depicted in FIG. 2, the conductive pad 202, the backing 204 and the electrode 206 are permanently bonded together using adhesives. Alternatively, the conductive pad 202, the backing 204 and the electrode 206 may be coupled by other methods or combination thereof, including sewing, binding, heat staking, riveting, screwing and clamping among others.

The conductive pad 202 includes dielectric pad body 260 and one or more conductive elements 262. The conductive elements 262 are coupled by lead 122A to the power source 124 and are adapted to contact the surface of the substrate that is disposed on the dielectric pad body 260 during processing. The lead 112A may by coupled to the conductive elements 262 in any number of methods that facilitate good electrical connection between the conductive elements 262 and the power source 124, for example, by soldering, stacking, brazing, clamping, crimping, riveting, fastening, conductive adhesive or by other methods or devices that facilitate good electrical connection between the lead 112A and the conductive elements 262.

The dielectric pad body 260 is typically fabricated from polymeric materials compatible with process chemistry, examples of which include polyurethane, polycarbonate, fluoropolymers, PTFE, PTFA, polyphenylene sulfide (PPS), or combinations thereof, and other polishing materials used in polishing substrate surfaces. The dielectric pad body 260 may also contain fillers and/or be foamed. Exemplary conventional material includes those made from polyurethane and/or polyurethane mixed with fillers, which are commercially available from Freudenberg with their FX9 pad. Other conventional polishing materials, such as a layer of compressible material, may also be utilized for the dielectric pad body 260. Compressible materials include, but are not limited to, soft materials such as compressed felt fibers leached with urethane or foam. The dielectric pad body 260 is generally between about 10 to about 100 mils thick.

The dielectric pad body 260 has a first side 208 and a second side 210. The first side 208 is adapted to contact the substrate 108 (shown in phantom in FIG. 2) during processing. The first side 208 may include grooves, embossing or other texturing to promote polishing performance. The dielectric pad body 260 may be solid, impermeable to electrolyte, permeable to electrolyte or perforated. The first side 208 additionally includes one or more slots 264 or other feature that retains the conductive elements 262. In the embodiment depicted in FIG. 2, the dielectric pad body 260 is perforated with a plurality of apertures 212 adapted to allow flow of electrolyte therethrough and a plurality of slots 264 having the conductive elements 262 disposed therein.

The conductive elements 262 may include conductive polymers, polymer composites with conductive materials, conductive metals or polymers, conductive fillers, graphitic materials, or conductive doping materials, or combinations thereof. The conductive elements 262 generally have a bulk resistivity or a bulk surface resistivity of about 10 Ω-cm or less. In the embodiment depicted in FIG. 2, the conductive elements 262 are a plurality of electrically conductive fibers, stands and or flexible fingers, such as carbon fibers or other conductive, compliant (i.e., flexible) material that contact the substrate while processing. Alternatively, the conductive elements 262 may be rollers, balls, rods, bars, mesh or other shape that facilitates conductive contact between the substrate disposed on the conductive pad 202 and the power source 124. Examples of conductive pads that may be adapted to benefit from the invention are described in U.S. Provisional Patent Application Serial No. 60/342,281, filed Dec. 19, 2001; U.S. patent application Ser. No. ______, filed ______ by Duboust et al., (Attorney Docket No. 6636/CMP/CMP/RKK) entitled “METHOD AND APPARATUS FOR FACE-UP SUBSTRATE POLISHING”; and U.S. patent application Ser. No. 10/033,732, filed Dec. 27, 2001, all of which are incorporated herein by reference in their entireties.

The backing 204 is coupled to the second side 210 of the dielectric pad body 260. The backing 204 is typically fabricated from a material softer, or more compliant, than the material of the dielectric pad body 260. The difference in hardness or durometer between the dielectric pad body 260 and the backing 204 may be chosen to produce a desired polishing/plating performance. The backing 204 may also be compressive. Examples of suitable backing materials include, but are not limited to, foamed polymer, elastomers, felt, impregnated felt and plastics compatible with the polishing chemistries.

The backing 204 has a first side 214 and a second side 216. The first side 214 is coupled to the second side 210 of the dielectric pad body 260. The backing 204 typically has a thickness in the range of about 5 to about 100 mils, and in one embodiment, is about 5 mils thick. The backing 204 may be solid, impermeable to electrolyte, permeable to electrolyte or perforated. In one embodiment depicted in FIG. 2, the backing 204 is configured to allow electrolyte therethrough, and may be permeable, have holes formed therethrough or a combination thereof. In the embodiment depicted in FIG. 2, the backing 204 is perforated with a plurality of apertures 218 adapted to allow flow of electrolyte therethrough. The apertures 218 of the backing 204 typically, but not necessarily, align with the apertures 212 of the dielectric pad body 260.

The electrode 206 typically is comprised of the material to be deposited or removed, such as copper, aluminum, gold, silver, tungsten and other materials which can be electrochemically deposited on the substrate 108. For electrochemical removal processes, such as anodic dissolution, the electrode 206 may include a non-consumable electrode of a material other than the deposited material, such as platinum for copper dissolution. The non-consumable electrode is used in planarization processes combining both electrochemical deposition and removal.

Alternatively, the electrode 206 may be consumable. As the pad assembly 122 is readily replaceable as a unit, periodic replenishment of the electrode 206 by replacing the pad assembly 122 is quickly and efficiently performed without substantially affecting processing throughput. Moreover, the electrode 206 may be configured to have a service life similar to that of the conductive pad 202 so that replacement of the pad assembly 122 both replenishes the electrode 206 and conductive pad 202 simultaneously. Furthermore, as the electrode 206 is recessed from the first side 208 of the dielectric pad body 260 (i.e., is in a spaced-apart relation), the first side 208 of the dielectric pad body 260 may be readily conditioned without damaging the electrode 202 or creating a condition conducive to substrate damage or scratching. The conditioning of the pad assembly 122 may optionally occur during substrate processing.

The electrode 206 has a first side 220 and a second side 222. The first side 220 of the electrode 206 is coupled to the second side 216 of the backing 204. The electrode 206 may be solid, impermeable to electrolyte, permeable to electrolyte or perforated. In the embodiment depicted in FIG. 2, the electrode 206 is configured to allow electrolyte therethrough. The electrode 206 may be permeable, have holes formed therethrough or a combination thereof. The electrode 206 may range in thickness from foils to greater than 100 mils thick.

The second side 222 of the electrode 206 is disposed on the bottom 144 of the basin 104. The second side 222 is coupled to the lead 112B that is typically routed with lead 112A (that is coupled to the dielectric pad body 260) through the basin 104 to the power source 124 (as shown in FIG. 1). The lead 112B may by coupled to the second side 222 in any number of methods that facilitate good electrical connection between the electrode 206 and the power source 124, for example, by soldering, stacking, brazing, clamping, crimping, riveting, fastening, conductive adhesive or by other methods or devices that facilitate good electrical connection between the lead 112A-B and the electrode 206. Alternatively, the leads 112A-B may be routed over the sidewalls 146 of the basin 104 to the power source 124 to eliminate the need for liquid seals around the leads 112A-B and the basin 104. Optionally, the leads 112A-B may be coupled to the power source 124 using a single disconnect 266, typically disposed in the basin 104, to further facilitate removal of the pad assembly 122.

The second side 222 of the electrode 206 may be adhered to the bottom 144 of the basin 104 with a removable adhesive to prevent the pad assembly 122 from moving during polishing while allowing the pad assembly 122 to be replaced. The pad assembly 122 may alternatively be clamped, fastened or secured to the basin 104 by other methods.

As the pad assembly 122 is disposed directly on the bottom 144 of the basin 104, typically without any intervening members, the sidewalls 146 of the basin 104 may be much shorter than conventional designs, resulting in a shallow processing cell. Advantageously, this shallow design of the basin 104 minimizes the amount of electrolyte utilized during processing. As small amounts of electrolyte are now required, the electrolyte may be cost effectively discarded after a single use, additionally eliminating the need for costly electrolyte recirculation and monitoring systems that are currently utilized on state of the art systems.

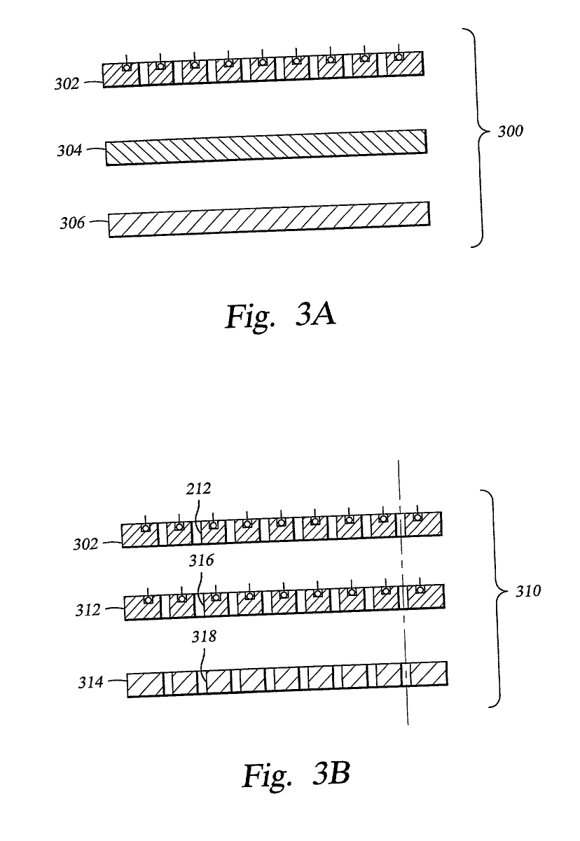

FIGS. 3A-B depicts embodiments of two alternative pad assemblies. Referring to FIG. 3A, a pad assembly 300 includes a conductive pad 302 coupled to a backing 304 and an electrode 306 to form a unitary, replaceable body that facilitates removal and replacement of the pad assembly 300 from the basin 104. Typically, the conductive pad 302, the backing 304 and the electrode 306 are adhered or bonded to one another as described with reference to the pad assembly 122 above. The conductive pad 302 includes a dielectric pad 332 and one or more conductive members 332 similar to the conductive pad 202. The electrode 306 is configured similar to the electrode 206 of the pad assembly 122. The backing 304 is generally similar to the backing 204 except that the backing 304 does not include apertures.

Referring to FIG. 3B, a pad assembly 310 includes a conductive pad 302 coupled to a backing 312 and an electrode 314 to form a unitary, replaceable body that facilitates removal and replacement of the pad assembly 310 from the basin 104. Typically, the conductive pad 302, the backing 312 and the electrode 314 are adhered or bonded to one another as described with reference to the pad assembly 122 above. The conductive pad 302 and backing 314 are configured similar to the conductive pad 202 and the backing 314 of the pad assembly 122. The electrode 312 is generally similar to the electrode 206 except that the electrode 312 includes a plurality of apertures 316 formed therethrough to allow passage of electrolyte through the electrode 312. In one embodiment, apertures 212, 316 and 318 align to promote electrolyte flow through the pad assembly 310 with minimal resistance.

An exemplary mode of operation of the processing cell 100 is described primarily with reference to FIG. 1. In operation, the substrate 108 is retained in the polishing head 102 and moved over the pad assembly 122 disposed in the basin 104. The polishing head 102 is lowered towards the basin 104 to place the pad assembly 122 in contact with the substrate 108 or at least proximate thereto. Electrolyte is supplied to the basin assembly 102 through the outlet 103 and flows into the pad assembly 122 through the apertures 212, 218 in the upper layers (i.e., conductive pad 202 and backing 204) of the pad assembly 122.

A bias voltage is applied from the power source 124 between the conductive elements 262 of the conductive pad 202 and the electrode 206 of the pad assembly 122 through the rotary union 140. The conductive elements 262 are in contact with the substrate and applied a bias thereto. The electrolyte filling the apertures 212, 218 between the electrode 206 and the substrate 108 provides a conductive path between the power source 124 and substrate 108 to drive an electrochemical polishing process that results in the removal of conductive material, such as copper, disposed on the surface of the substrate 108, by an anodic dissolution method.

The substrate 108 and pad assembly 122 are moved relative to one another to uniformly polish the substrate surface. A contact force of about 6 psi or less is typically used to hold the substrate 108 against the pad assembly 122. A contact force of about 2 psi or less may be used when polishing substrates containing low dielectric constant material.

In anodic dissolution, the bias is applied to the electrode 206 of the pad assembly 122, performing as a cathode, and the conductive pad 202 and the substrate 108, performing as the anode. The application of the bias allows removal of deposited material from the substrate surface. The bias may include the application of a voltage of about 15 volts or less to the substrate surface. A voltage between about 0.1 volts and about 10 volts may be used to dissolve copper-containing material from the substrate surface into the electrolyte. Alternatively, the bias may be a current density between about 0.1 milliamps/cm² and about 50 milliamps/cm², or between about 0.1 amps to about 20 amps for a 200 mm substrate. It is believed that biasing the substrate via the conductive pad 202 provides uniform dissolution of conductive materials, such as metals, into the electrolyte from the substrate surface as compared to conventional polishing devices which bias the substrate through the substrate's perimeter.

The bias applied to perform the anodic dissolution process may be varied in power and application, depending on the user requirements in removing material from the substrate surface. For example, a time varying anodic potential may be provided to the conductive pad 202. The bias may also be applied by electrical pulse modulation techniques. In one embodiment, an electrical pulse modification technique includes applying a constant current density or voltage over the substrate for a first time period, then applying a constant reverse voltage over the substrate for a second time period, and repeating the first and second steps. For example, the electrical pulse modification technique may use a varying potential from between about −0.1 volts and about −15 volts to between about 0.1 volts and about 15 volts.

Conductive materials can be removed from at least a portion of the substrate surface at a rate of about 15,000 Å/min or less, such as between about 100 Å/min and about 15,000 Å/min. In one embodiment of the invention where the copper material to be removed is less than 12,000 Å thick, the voltage may be applied to the pad assembly 122 to provide a removal rate between about 100 Å/min and about 8,000 Å/min.

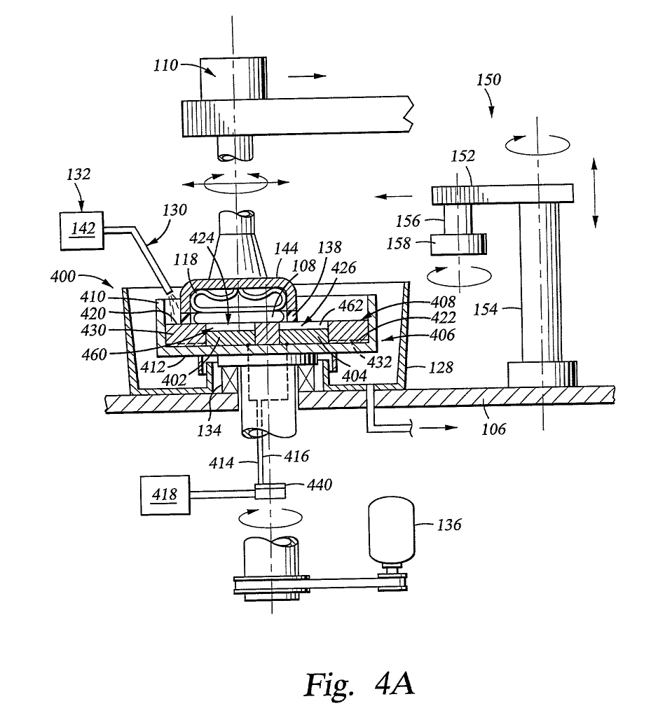

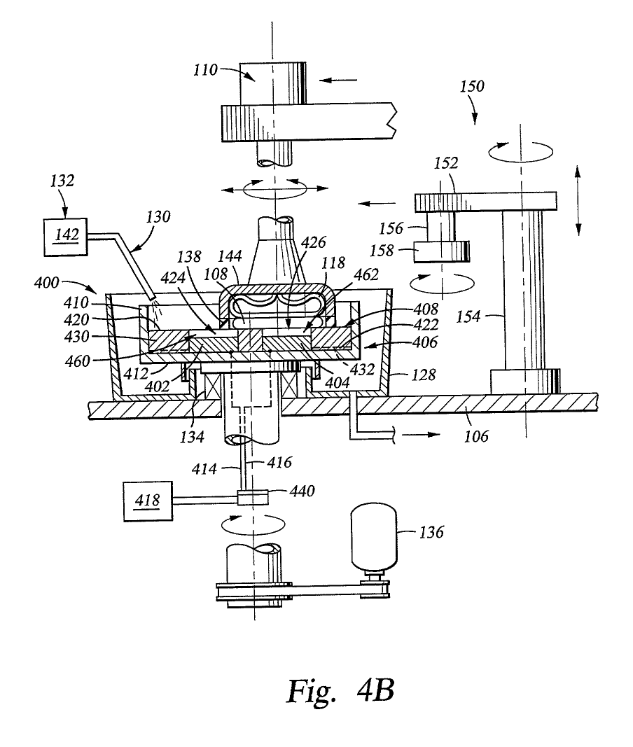

FIGS. 4A-B depict another embodiment of a processing cell 400. The processing cell 400 is generally similar to the processing cell 100 described above except that at least a first electrode 402 and a second electrode 404 are coupled to a basin 406 independent of a pad assembly 408 disposed in the basin 406.

The basin 406 generally includes sidewalls 410 and a bottom 412. Each electrode 402, 404 is coupled to the bottom 412 of the basin 406 in a spaced-apart relation. Each electrode 402, 404 is coupled by a separate lead 414, 416 to a different pole of a power source 418 through a slip ring 440 disposed below the basin 406.

In the embodiment depicted in FIG. 4A, the first electrode 402 is configured as a non-consumable anode, and is typically fabricated from a noble metal, such as platinum, gold, graphite and the like. The second electrode 404 is configured as an cathode, and is typically fabricated from a highly conductive material, examples of which are noble metals, aluminum and copper among other.

The pad assembly 408 generally comprises a dielectric body 430 having a polishing surface 420 adapted to contact the substrate while processing and an opposing second surface 422. At least a first aperture 424 and a second aperture 426 are formed through the pad assembly 408 between the polishing and second surfaces 420, 422. The first and second apertures 424, 426 are configured to respectively receive the first and second electrodes 402, 404 as the pad assembly 408 is disposed on the bottom 412 of the basin 406. The thickness of the body 430 is selected so that the electrodes 402, 404 remain below the polishing surface 420 during polishing, thus substantially preventing the electrodes 402, 404 from contacting a substrate 108 processed on the pad assembly 408. In one embodiment, the electrodes 402, 404 projecting above the bottom 412 of the basin 406 are recessed less than about 50 mils, an in one embodiment, is recess between about 10 to about 30 mils from the polishing surface 420 of the body 430. The pad assembly 408 may optionally include a backing 432 (shown in phantom in FIG. 4A) coupled to the second surface 422 to provide greater control of the polishing attributes of the pad assembly 408.

The apertures 424, 426 (and electrodes 402, 404) are generally spaced or configured so that at least a portion of each of the apertures 424, 426 is periodically exposed to atmosphere during processing. In other words, the substrate 108, while substantially covering the apertures 424, 426 during processing, periodically uncover portions of the apertures 424, 426 to allow any gases present between the electrodes 402, 404 and substrate 108 to be released, thereby enhancing polishing uniformity. Alternatively, the invention contemplates using a high electrolyte flow to flush out the gases present between electrodes 402, 404 and the substrate 108. Electrodes 402, 404 are not powered when they are not directly covered by the substrate 108.

As depicted in the top view of one embodiment of the body 430 depicted in FIG. 4C, the apertures 424, 426 are configured having a distance between opposing outer edges 452, 454 greater than a diameter of the substrate being polished while having a distance between inner edges 456, 458 of the apertures 424, 426 to the outer edges 452, 454 of the opposite aperture less than the diameter of the substrate.

Moreover, as the electrodes 402, 404 are recessed below the polishing surface 420 of the body 430, the pad assembly 408 may be conditioned without damage to the electrodes 402, 404. Thus, the life of the pad assembly 408 is advantageously increased without deteriorating electrical properties of the cell 400. As only the body 430 (and backing 432, when used) is replaced during service, both the cost of consumables and speed of replacement are advantageously minimized.

In operation, the region in each aperture 424, 426 between the electrodes 402, 404 and the substrate 108 is filled with electrolyte and becomes two separate electrochemical cells 460, 462 as bias is applied to each electrode 402, 404 from the power source 418. In the cell 402 above the second electrode 404, OH⁻ ions migrate towards the second electrode 404 and form O₂ bubbles. H⁺ ions migrate to the metal surface (on the substrate) and form H₂. The electrons required to accomplish the H₂ generation are supplied by the process that simultaneously occurs in the cell 460 above the first electrode 402. In cell 460, the Cu or other metal film present on the surface of the substrate 108 loses electrons into the electrolyte, and metal ions, such as H⁺, migrate to the first electrode 402. This double cell process completes the current loop, polishing the metal film on the substrate 108 without contact by solid conductor.

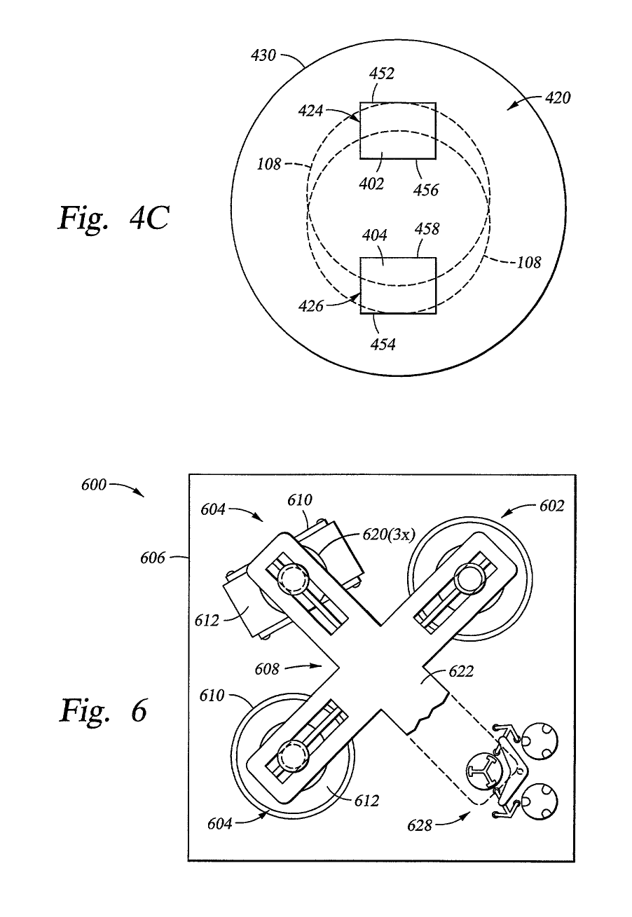

FIG. 5 depicts one embodiment of a polishing system 500 having a process cell 502 suitable for electrochemical deposition and/or chemical mechanical polishing, such as electrochemical mechanical polishing (ECMP) or electrochemical mechanical plating processes (ECMPP) station. The process cell 502 generally includes a base 542 having a basin assembly 506 disposed thereon and a head assembly 510 supported over the basin assembly 506 by a head assembly frame 552. The basin assembly 506 is generally similar to the basin 104 described above, and may be coupled to or rotated above the base 542 on one or more bearings 508 (one is shown). Alternatively, the basin assembly 506 may be configured similar to basin 406 to utilize a pad assembly 408.

The head assembly 510 includes a polishing head 512 that retains a substrate 108 and can move to place the substrate 108 in contact with a pad assembly 122 retained in the basin assembly 506 during processing. The polishing head 512 is generally similar to the polishing head 102 described above.

The head assembly 510 is generally mounted onto the head assembly frame 552 that includes a mounting post 554 and a cantilever arm 556. The mounting post 554 is mounted to the base 542 of the polishing system 500, and the cantilever arm 556 extends laterally from an upper portion of the mounting post 554. The mounting post 554 may provide rotational movement with respect to a vertical axis along the mounting post to allow the head assembly 510 to move laterally. The head assembly 510 is attached to a mounting plate 560 disposed at the distal end of the cantilever arm 556. The lower end of the cantilever arm 556 is connected to a cantilever arm actuator 520, such as a pneumatic cylinder, mounted on the mounting post 554. The cantilever arm actuator 520 provides pivotal movement of the cantilever arm 556 with respect to the joint between the cantilever arm 556 and the mounting post 554. When the cantilever arm actuator 520 is retracted, the cantilever arm 556 moves the head assembly 510 away from the basin assembly 506 to provide the spacing required to remove or load the substrate from the basin assembly 506 of the polishing system 500. When the cantilever arm actuator 520 is extended, the cantilever arm 556 moves the head assembly 510 and substrate 108 toward the basin assembly 506 to contact the pad assembly 122 retained in the basin assembly 506.

The head assembly 510 generally comprises the polishing head 512 and a polishing head actuator 558. The polishing head actuator 558 is coupled to the mounting plate 560, and includes a head shaft 562 extending downwardly through the mounting plate 560. The lower end of the head shaft 562 is connected to the polishing head 512 to allow vertical movement of the polishing head 512.

The polishing head actuator 558 additionally may be configured to provide rotary motion to the polishing head 512. Relative motion between the substrate and the polishing head 512 during the anodic dissolution process typically enhances the polishing results. The polishing head 512 can also be rotated as the polishing head 512 is lowered to contact the substrate with the pad assembly 122 disposed in the basin assembly 506 as well as when the polishing head 512 is in a raised or partially raised position. In a raised or partially raised position, the head 512 may be spun to remove electrolyte from the polishing head 512.

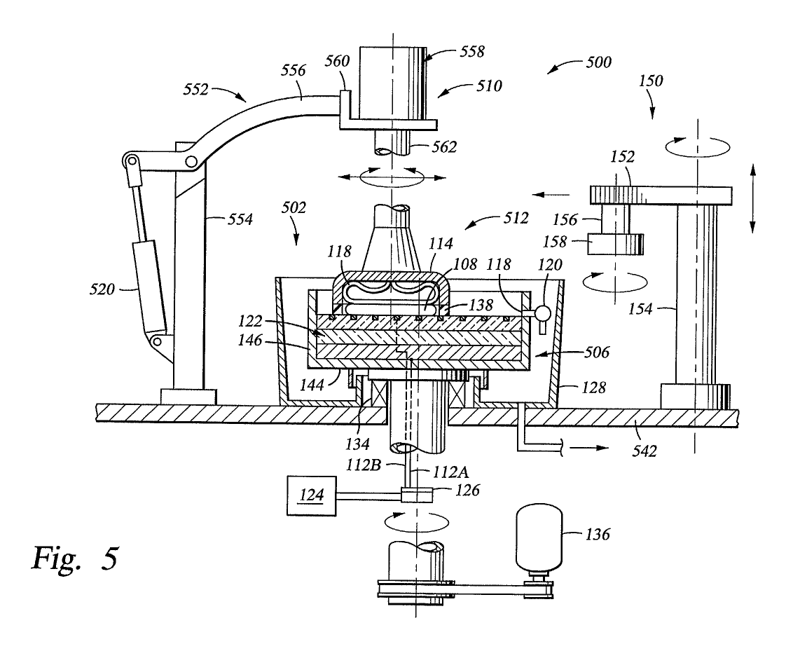

FIG. 6 depicts one embodiment of a polishing system 600 having at least one process cell 602 suitable for electrochemical deposition and/or chemical mechanical polishing, such as electrochemical mechanical polishing (ECMP) station and chemical mechanical polishing station 604 disposed on a base 606. A substrate transfer mechanism 608 is coupled to the base 606 for transferring substrates between the process cell 602 and polishing station 604. The process cell 602 is generally similar to the processing cell 100 described above.

The transfer mechanism 608 generally includes at least one polishing head 620 similar to the polishing head 102 described above. In the embodiment depicted in FIG. 6, the transfer mechanism 608 includes a transfer device such as a carousel 622 that rotatably supports a plurality of polishing heads 620 (three are shown). Each polishing head 620 is coupled to the carousel by an arm 626. One arm 626 and polishing head 620 are removed to show a transfer station 628. One transfer station that may be adapted to benefit from the invention is described in U.S. Pat. No. 6,156,124, issued Dec. 5, 2000 to Tobin, which is hereby incorporated herein by reference in its entirety.

Each polishing head 620 may be selectively positioned above one of the process cells 602 and polishing stations 604 to process the substrate. A substrate may be processed sequentially in any of the process cells 602 and/or polishing stations 604 while remaining retained in a single polishing head 620. A drive system 624 is coupled to each of the polishing heads 620 to facilitate at least a portion of the polishing motion between the substrate and the process cell 602 or polishing station 604 positioned therebelow. One transfer mechanism that may be adapted to benefit from the invention is described in U.S. Pat. No. 5,738,574, issued Apr. 14, 1998 to Tolles et al., which is hereby incorporated herein by reference in its entirety.

The polishing station 604 generally includes a rotatable platen 610 that supports a polishing material 612. The polishing material 612 is typically fabricated from polymeric materials compatible with process chemistry, examples of which include polyurethane, polycarbonate, fluoropolymers, PTFE, PTFA, polyphenylene sulfide (PPS), or combinations thereof, and other polishing materials used in polishing substrate surfaces. The polishing material 612 may also contain fillers and/or be foamed. Exemplary conventional material includes those made from polyurethane and/or polyurethane mixed with fillers, which are commercially available from Freudenberg with their FX9 pad. Other conventional polishing materials, such as a layer of compressible material, may also be utilized for the polishing material 612. Compressible materials include, but are not limited to, soft materials such as compressed felt fibers leached with urethane or foam. Alternatively, the polishing material 612 may be in the form of a polishing web of material that comprise a plurality of abrasive elements suspended in a polymer binder tensioned between rollers disposed on either side of the platen 610. Typically, a polishing medium, such as an abrasive slurry, de-ionized water or other liquid or polishing compound is supplied between the polishing material 612 and the substrate supported in the polishing head 620 to facilitate material removal from the substrate. One polishing system having a polishing station that may be adapted to benefit from the invention is described in U.S. Pat. No. 6,244,935, issued Jun. 12, 2001 to Birang et al., which is hereby incorporated herein by reference in its entirety.

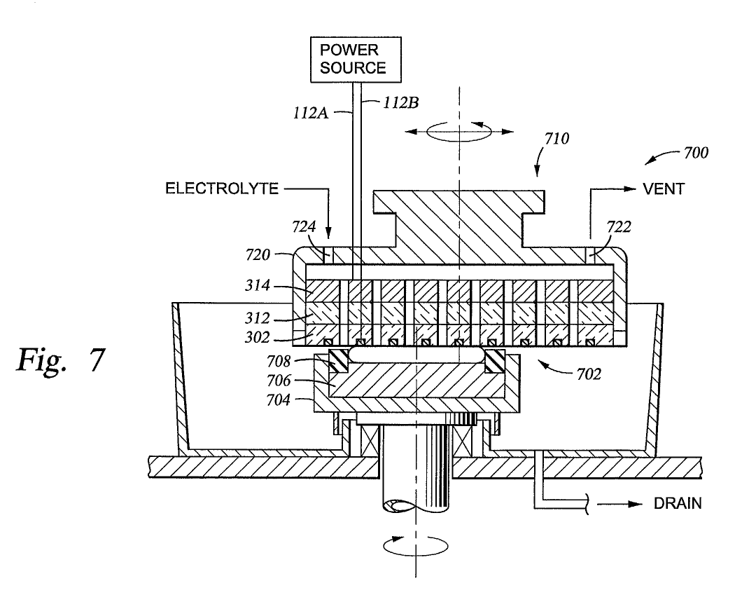

FIG. 7 is another embodiment of a process cell 700 that utilizes a pad assembly 702 similar to the pad assembly 310 described above. The process cell 700 generally includes a basin 704 that retains a substrate 108 therein during processing. The basin 704 generally includes a carrier 706 and a retaining ring 708. The carrier 706 is adapted to support the substrate within the basin 704. The retaining ring 708 is coupled to the carrier 706 and circumscribing the substrate 108 to substantially limits substrate movement during processing.

A polishing head 710 is movably disposed over the basin 704. The pad assembly 702 is secured to a housing 720 of the polishing head 710. The pad assembly 702 is orientated with a conductive pad 302 of the pad assembly 702 facing the basin 704 and an electrode 314. Electrolyte enters the polishing head 710 through an inlet 724 formed in the housing 720. Electrolyte flows from the inlet 724 through the pad assembly 702 to the substrate 108 disposed in the basin 704. Alternatively, the basin 704 may be flooded with electrolyte to a level that wets the electrode 314 of the pad assembly 702 within the polishing head 710.

The housing 720 of the polishing head 710 typically includes a vent 722 formed therein. Gases formed at the electrode 314 (or otherwise present at the substrate's surface) pass through the apertures in the pad assembly 702 and out of the housing 720 through the vent 722. The removal of gases improves process uniformity by preventing electrical insulation of the substrate's surface due to electrolyte displacement by gas bubbles. One processing cell that may be adapted to benefit from the invention is described in U.S. Provisional Patent Application Ser. No. 60/342,281, filed Dec. 19, 2001, which is incorporated herein by reference in its entirety.

Therefore, the present invention substantially reduces the amount of consumables used during processing by minimizing the volume of electrolyte used and facilitating pad conditioning. Moreover, as pad assembly is a unitary body, replacement of the pad assembly is facilitated with minimal down time. As such, electrochemical processing of the substrate is enhanced.

While the foregoing is directed to various embodiments of the invention, other and further embodiments of the invention may be devised without departing from the basic scope thereof, and the scope thereof is determined by the claims that follow.

What is claimed is:

1. Apparatus for processing a substrate comprising:
a conductive pad adapted to be coupled to a first pole of a power source having a first surface adapted to polish a substrate;
a backing layer coupled to a second surface of the conductive pad; and
a conductive layer coupled to the backing layer and adapted to be coupled to a second pole power source.

2. The apparatus of claim 1, wherein the conductive pad and backing are perforated.

3. The apparatus of claim 1, wherein the conductive pad and backing layer are permeable.

4. The apparatus of claim 1, wherein the backing layer is softer than the conductive pad.

5. The apparatus of claim 4, wherein the backing layer is comprised of a foamed polymer, an elastomer, a felt material, an impregnated felt or a plastic.

6. The apparatus of claim 1, wherein the conductive pad, the backing and the conductive layer are joined by adhesive.

7. The apparatus of claim 1, wherein the conductive pad is a polymer having conductive elements exposed to the first surface.

8. The apparatus of claim 1, wherein the conductive pad is a fluoropolymer having conductive elements exposed to the first surface.

9. The apparatus of claim 1, wherein the backing layer is less than about 5 mils thick.

10. The apparatus of claim 1, wherein the conductive pad is permeable to electrolyte or perforated, and the backing is not.

11. The apparatus of claim 1, wherein the backing and the electrode are permeable to electrolyte or perforated.

12. The apparatus of claim 1, wherein the conductive pad further comprises:
a dielectric body having one or more conductive elements exposed on the first surface of the conductive pad.

13. The apparatus of claim 12, wherein the conductive elements are coupled to the first pole of the power source.

14. The apparatus of claim 12, wherein the conductive elements comprise one or more elements selected from the group consisting of rollers, balls, rods, bars, a mesh, fibers, stands and flexible fingers.

15. Apparatus for processing a substrate comprising:
a basin;
a first electrode coupled to a bottom of the basin;
a second electrode coupled to the bottom of the basin, the first and second electrodes adapted to be electrically biased relative to each other;
a dielectric pad having a first side and a second side, the second side disposed on the bottom of the basin;
a first aperture formed through the dielectric pad and having the first electrode extending partially therethrough; and
a second aperture formed through the dielectric pad and having the second electrode extending partially therethrough.

16. The apparatus of claim 15, wherein the first electrode is at least partially formed from a noble metal.

17. The apparatus of claim 15, wherein the first electrode is recessed about less than about 50 mils from the first side.

18. Apparatus for processing a substrate comprising:
a basin;
a dielectric pad having a first side and a second side disposed on a bottom of the basin;
a first electrochemical cell formed in the dielectric pad; and
a second electrochemical cell formed in the dielectric pad and adapted to have a polarity opposite the first electrochemical cell.

19. The apparatus of claim 18 further comprising:
a cathode coupled to the bottom of the basin and projecting into the first cell; and
an anode coupled to the bottom of the basin and projecting into the second cell.

20. The apparatus of claim 19, wherein the cathode is recessed below a first surface of the dielectric pad.

21. The apparatus of claim 19, wherein the cathode is comprised of a noble metal and the anode is comprised of a highly conductive metal.

22. Apparatus for processing a substrate comprising:
a) a polishing pad assembly comprising:
a dielectric layer having a substrate supporting surface;
a plurality of conductive elements coupled to the dielectric layer and adapted to contact the substrate;
a backing coupled to the dielectric layer; and
an electrode coupled to the backing;
b) a basin having the pad assembly disposed therein, the dielectric layer of the pad assembly facing an open end of the basin; and
c) a polishing head disposed above the open end of the basin and adapted to place a substrate retained therein in contact with the pad assembly disposed in the basin.

23. The apparatus of claim 22, wherein the electrode, the dielectric layer, the backing and the conductive elements forming a unitary, replaceable body.

24. The apparatus of claim 22, wherein the dielectric layer and backing are perforated.

25. The apparatus of claim 22, wherein the dielectric layer and backing layer are permeable.

26. The apparatus of claim 22, wherein the backing is softer than the dielectric layer.

27. The apparatus of claim 26, wherein the backing is comprised of a foamed polymer, an elastomer, a felt material, an impregnated felt or a plastic.

28. The apparatus of claim 27, wherein the dielectric layer is a polymer.

29. The apparatus of claim 27, wherein the backing is less than about 5 mils thick.

30. The apparatus of claim 27, wherein the dielectric layer is permeable to electrolyte or perforated, and the backing is not.

31. The apparatus of claim 27, wherein the backing and the electrode are permeable to electrolyte or permeable.

32. The apparatus of claim 27 further comprising a power source coupled to the conductive element and the electrode and adapted to applied a bias therebetween.

33. Apparatus for processing a substrate comprising:
a basin adapted to retain a substrate therein;
a housing supported over the basin and having an open end facing the basin;
a dielectric layer coupled to the open end of the housing;
a backing coupled to the dielectric layer; and
an electrode disposed in the housing and coupled to backing, the electrode, the backing and the dielectric layer forming a replaceable, unitary body.

34. The apparatus of claim 33, wherein the housing further comprises:
a vent formed therein.

35. The apparatus of claim 33, wherein the electrode, the backing and the dielectric layer are perforated.

36. Apparatus for polishing a substrate, comprising:
a basin having sides and a bottom adapted to contain electrolyte during a polishing process;
a dielectric pad disposed in the basin;
at least a first aperture and a second aperture formed in a polishing surface of the dielectric pad;
a first electrode disposed in the first aperture, the first electrode recessed from the polishing surface of the dielectric pad; and
a second electrode disposed in the second aperture, the second electrode recessed from the polishing surface of the dielectric pad.

37. A method for electro-chemical processing a substrate, the method comprising:
placing the substrate in contact with a surface of a dielectric pad having a first aperture and a second aperture formed in the surface;
moving the substrate and the dielectric pad relative to each other;
creating a first conductive path between an anode and the substrate through the first aperture; and
creating a second conductive path between a cathode and the substrate through the second aperture.

38. The method of claim 37, wherein the steps of creating the conductive paths further comprises:
flowing the apertures with electrolyte.

39. The method of claim 37 further comprising:
exposing at least a portion of the apertures from under the substrate while processing.

40. The method of claim 37 further comprising:
removing gas from the electrolyte disposed in the apertures by intermittently uncovering at least a portion of the apertures.

41. The method of claim 37 further comprising conditioning the pad while the substrate is in contact with the pad.

42. The method of claim 37, further comprising removing the pad from the basin; and
placing a new pad over the electrodes.

43. The method of claim 37 further comprising:
moving the substrate in contact with the dielectric pad clear of the first aperture; and
removing voltage from the anode.

44. The method of claim 37 further comprising:

45. A method for fabricating a laminated conductive pad, the method comprising:
coupling a conductive polishing pad to a backing layer; and
coupling the backing layer to an conductive layer.

46. The method of claim 45, wherein the conductive polishing pad, backing layer and conductive layer are adhered together.

47. The method of claim 46 further comprising:
coupling a first electrical lead to conductive elements of the conductive pad; and
coupling a second electrical lead to the conductive layer.

48. A method for electro-chemical processing a substrate, the method comprising:
placing the substrate in contact with conductive elements disposed on a first surface of a dielectric pad;
moving the substrate and the dielectric pad relative to each other;
creating a plurality of conductive paths between the substrate and a conductive layer coupled to a second surface of the dielectric pad; and
applying an electrical bias between the substrate and the conductive layer.
